(19) United States
(12) Patent Application Publication
(10) Pub. No.: US 2022/0194742 A1
(43) Pub. Date: Jun. 23, 2022

(54) ELEVATOR SYSTEM WITH A CLIMBING COUNTERWEIGHT

(71) Applicant: OTIS ELEVATOR COMPANY, Farmington, CT (US)

(72) Inventors: Randy ROBERTS, Hebron, CT (US); Kiron BHASKAR, Farmington, CT (US)

(21) Appl. No.: 17/128,925

(22) Filed: Dec. 21, 2020

(51) Int. Cl. B66B 11/00; B66B 9/02; B66B 7/06; B66B 1/34; B66B 1/30; B66B 1/42; B66B 17/12

(52) U.S. Cl. CPC B66B 11/0055; B66B 9/02; B66B 7/064; B66B 17/12; B66B 1/30; B66B 1/42; B66B 1/3492

(57) ABSTRACT

An illustrative example embodiment of an elevator includes an elevator car frame. A drive mechanism is situated near only one side of the elevator car frame. The drive mechanism includes at least one rotatable drive member that is configured to engage a vertical surface near the one side of the elevator car frame, selectively cause movement of the elevator car frame as the rotatable drive member rotates along the vertical surface, and selectively prevent movement of the elevator car frame when the drive member does not rotate relative to the vertical surface. A biasing mechanism urges the rotatable drive member in a direction to engage the vertical surface. At least one stabilizer is situated near the one side of the elevator car frame and is configured to prevent the elevator car frame from tipping away from the vertical surface.

### BACKGROUND

Elevator systems have proven useful for carrying passengers among various levels within a building. There are various types of elevator systems. For example, some elevator systems are considered hydraulic and include a piston or cylinder that expands or contracts to cause movement of the elevator car. Other elevator systems are traction-based and include roping between the elevator car and a counterweight. A machine includes a traction sheave that causes movement of the roping to achieve the desired movement and positioning of the elevator car. Hydraulic systems are generally considered useful in buildings that have only a few stories.

Each of the known types of elevator systems has features that present challenges for some implementations.

### SUMMARY

An illustrative example embodiment of an elevator includes an elevator car and a counterweight. A suspension assembly couples the elevator car and counterweight. A drive mechanism on the counterweight includes at least one rotatable drive member that is configured to engage a vertical surface near the counterweight to selectively cause movement of the counterweight and the elevator car as the rotatable drive member rotates along the vertical surface.

In addition to one or more of the features described above, or as an alternative, the at least one rotatable drive member comprises a wheel and a motor supported at least partially within the wheel.

In addition to one or more of the features described above, or as an alternative, the at least one rotatable drive member comprises a plurality of wheels, one of the wheels is configured to engage one vertical surface near one side of the counterweight, and another of the wheels is configured to engage another vertical surface near another side of the counterweight.

In addition to one or more of the features described above, or as an alternative, the vertical surfaces face toward each other, and the counterweight is situated between the vertical surfaces.

In addition to one or more of the features described above, or as an alternative, the elevator includes a biasing mechanism that urges the at least one rotatable drive member in a direction to engage the vertical surface.

In addition to one or more of the features described above, or as an alternative, the drive mechanism establishes a portion of a mass of the counterweight.

In addition to one or more of the features described above, or as an alternative, the drive mechanism includes a motor for rotating the rotatable drive member, the drive mechanism includes a power source for powering the motor, and the motor and the power source establish some of the portion of the mass of the counterweight.

In addition to one or more of the features described above, or as an alternative, the drive mechanism includes a motor for rotating the rotatable drive member, and the elevator comprises a traveling cable having one end associated with the counterweight to provide at least power or control signals to the motor to selectively cause the rotatable drive member to rotate.

In addition to one or more of the features described above, or as an alternative, the drive mechanism includes a motor configured to selectively cause rotation of the drive member, the motor has a length and a width, the length is greater than the width, and the length is oriented parallel to the vertical surface.

In addition to one or more of the features described above, or as an alternative, the at least one rotatable drive member is configured to selectively prevent movement of the counterweight and the elevator car when the drive member does not rotate relative to the vertical surface.

An illustrative example embodiment of a method of controlling elevator car movement in an elevator system that has an elevator car coupled to a counterweight by a suspension assembly includes operating a drive mechanism on the counterweight to cause at least one rotatable drive member of the drive mechanism that engages a vertical surface near the counterweight to rotate along the vertical surface to selectively cause movement of the counterweight and corresponding movement of the elevator car.

In addition to one or more of the features described above, or as an alternative, the method includes operating the drive mechanism on the counterweight to cause the at least one rotatable drive member to remain stationary relative to the vertical surface to selectively prevent movement of the counterweight and corresponding movement of the elevator car.

In addition to one or more of the features described above, or as an alternative, the method includes biasing the at least one rotatable drive member into engagement with the vertical surface.

In addition to one or more of the features described above, or as an alternative, the at least one rotatable drive member comprises a plurality of wheels, one of the wheels is configured to engage one vertical surface near one side of the counterweight, another of the wheels is configured to engage another vertical surface near another side of the counterweight, the vertical surfaces face toward each other, and the counterweight is situated between the vertical surfaces.

In addition to one or more of the features described above, or as an alternative, the method includes using a mass of the drive mechanism to establish a portion of the mass of the counterweight.

In addition to one or more of the features described above, or as an alternative, the method includes determining a desired position of the elevator car, determining a desired counterweight position corresponding to the desired position of the elevator car, and moving the counterweight into the desired counterweight position.

In addition to one or more of the features described above, or as an alternative, the method includes monitoring the position of the elevator car and moving the counterweight to place the elevator car in the desired position of the elevator car.

In addition to one or more of the features described above, or as an alternative, the method includes determining a desired position of the elevator car, determining a current position of the elevator car, and moving the counterweight to move the elevator until the current position of the elevator car corresponds to the desired position of the elevator car.

In addition to one or more of the features described above, or as an alternative, the method includes adjusting a position of the elevator car near the desired position of the elevator car using a leveling and holding mechanism on the elevator car.

In addition to one or more of the features described above, or as an alternative, the method includes determining a desired position of the counterweight corresponding to the desired position of the elevator car and wherein moving the counterweight includes moving the counterweight into the desired position of the counterweight and subsequently adjusting the position of the counterweight to move the elevator car into the desired position of the elevator car based on an indication of the current position of the elevator car.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example embodiment of an elevator system including a climbing counterweight.

FIG. 2 schematically illustrates selected features of the counterweight embodiment of FIG. 1.

FIG. 3 schematically illustrates an example rotatable drive member useful, for example, with the embodiment shown in FIGS. 1 and 2.

FIG. 4 schematically illustrates an example configuration of a guide roller assembly configured to guide movement of the example counterweight along a vertical surface.

FIG. 5 schematically illustrates an example embodiment of another counterweight configuration.

### DETAILED DESCRIPTION

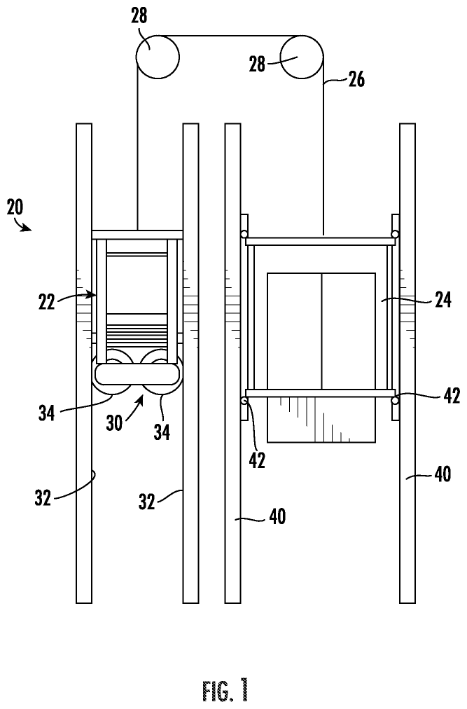

FIG. 1 schematically illustrates selected portions of an elevator system 20. A counterweight 22 is coupled to an elevator car 24 through a suspension assembly 26 that is at least partially wrapped about and supported by idler sheaves 28. The suspension assembly 26 includes at least one round rope in some embodiments and at least one flat belt in other embodiments.

The counterweight 22 includes a drive mechanism 30 that is configured to selectively move the counterweight to climb along vertical surfaces 32, which may be on beams or other structural members near the counterweight 22. The suspension assembly 26 couples the counterweight 22 with the elevator car 24 so that movement of the counterweight 22 results in corresponding movement of the elevator car 24. The drive mechanism 30 on the counterweight provides the propelling force to selectively move the elevator car 24 for providing elevator service among various levels in a building, for example.

As can be appreciated from FIGS. 1 and 2, the drive mechanism 30 includes drive members 34, which are wheels in the illustrated example, that engage the vertical surfaces 32. At least one of the drive members 34 is actively driven to selectively cause movement of the counterweight 22 and corresponding movement of the elevator car 24 as the at least one drive member 34 rotates along the corresponding vertical surface 32. In the example embodiment of FIGS. 1 and 2, at least the one drive member 34 selectively prevents movement of the counterweight 22 and corresponding movement of the elevator car 24 when the at least one drive member 34 does not rotate relative to the corresponding vertical surface 32. This can be accomplished by controlling the drive mechanism 30 to prevent the drive member 34 from rotating or by applying a brake to the drive member 34, for example.

In some embodiments the position of the elevator car 24 is maintained by a brake on or connected with the elevator car 24. For example, a brake mechanism on the elevator car 24 may apply a gripping or braking force to a guiderail that the elevator car 24 follows. Other embodiments include a brake associated with at least one of the sheaves 28 to prevent rotation of the sheave and thereby prevent movement of the suspension assembly, the elevator car 24 and the counterweight 22. Such a brake may operate like a machine brake in a traction-based elevator system by applying a braking force to the sheave 28 to prevent the sheave 28 from rotating. Other embodiments include a combination of such brake devices.

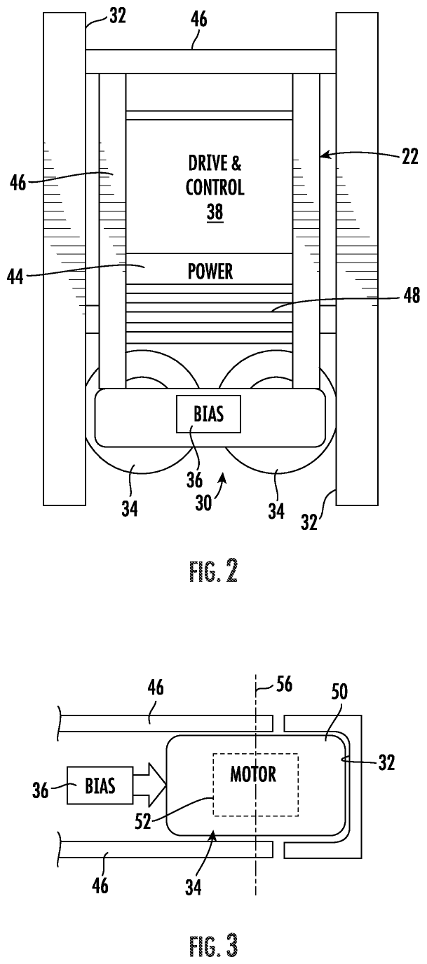

As schematically shown in FIGS. 2 and 3, a biasing mechanism 36 urges the drive members 34 into engagement with the vertical surfaces 32. The biasing mechanism 36 in some embodiments includes a sensor that detects the normal force for urging the drive members 34 into engagement with the vertical surfaces 32. Indications from the sensor are useful to adjust operation of the biasing mechanism 36 to ensure appropriate engagement and to reduce unnecessary wear on the drive members 34 under appropriate circumstances.

The drive mechanism 30 on the example counterweight 22 includes a drive and control unit 38 that includes a computing device, such as a processor and memory, that controls movement of the drive members 34 to control movement and position of the counterweight 22. In some embodiments, the drive and control unit 38 includes or has access to a database of counterweight positions that correspond to predetermined positions of the elevator car 24 so the drive and control unit 38 can achieve a position of the counterweight 22 to park the elevator car 24 where needed to provide requested elevator service.

In some embodiments, the drive and control unit 38 receives information regarding a detected or actual position of the elevator car 24 and uses such information for controlling movement of the counterweight 22 to achieve the desired elevator car position. For example, the drive and control unit 38 may use a counterweight position corresponding to a desired elevator car position as an initial target position of the counterweight 24 and information regarding the actual elevator car position to make adjustments to the counterweight position until the elevator car 24 is confirmed to be in the desired elevator car position. The elevator car position may be detected or determined using known techniques and devices.

In other embodiments, the drive and control unit 38 uses the elevator car position information as the primary control parameter to achieve desired car movement and position.

In the illustrated example embodiment of FIG. 1, the elevator car 24 moves along car guiderails 40 as the counterweight 22 moves along the vertical surfaces 32. The position of the counterweight 22 controls the position of the elevator car 24. The elevator car in this example includes a leveling and holding mechanism 42 that is configured to make some adjustment to the position of the elevator car 24 to level the car at a landing, for example, as passengers board or exit the elevator car 24. In an example embodiment, the car level is adjusted by a motorized roller assembly and the car position is held by a brake that engages at least a corresponding guiderail 40 or prevents movement of the roller assembly. A separate leveling and holding mechanism 42 associated with the elevator car allows for controlling the position of the elevator car 24 within acceptable tolerances at a landing, for example, without always requiring fine adjustments in the position of the counterweight 22.

Some embodiments do not include a separate leveling and holding mechanism 42. In such embodiments, the drive mechanism 30 is used to alter the position of the counterweight 22 for making relatively minor adjustments in the position of the elevator car 24 for leveling or releveling at a landing.

The drive mechanism in FIG. 2 includes a power source 44, such as a battery, to provide the power necessary for the drive members 34 to propel the counterweight 22 and the elevator car 24. One feature of including a power source 44 on the counterweight 22 is that all operative components of the drive mechanism 30 may be supported on the counterweight 22. Such an arrangement can make maintenance or repair easier as the counterweight 22 can be positioned in a convenient location in a hoistway where a mechanic can access the drive mechanism 30. Another feature of including the power source 44 on the counterweight 22 is that the power source 44 contributes additional mass to the drive mechanism 30 which establishes at least a portion of the mass of the counterweight 22.

In the example of FIG. 2, the counterweight 22 includes a frame 46 and weight plates 48 that, together with the drive mechanism 30, establish the desired mass of the counterweight 22.

FIG. 3 shows an example configuration of the drive members 34 and the vertical surfaces 32. The drive members 34 in this embodiment each include a wheel 50 with a hub motor 52 inside the wheel 50. This type of drive member 34 provides a compact and space-efficient arrangement.

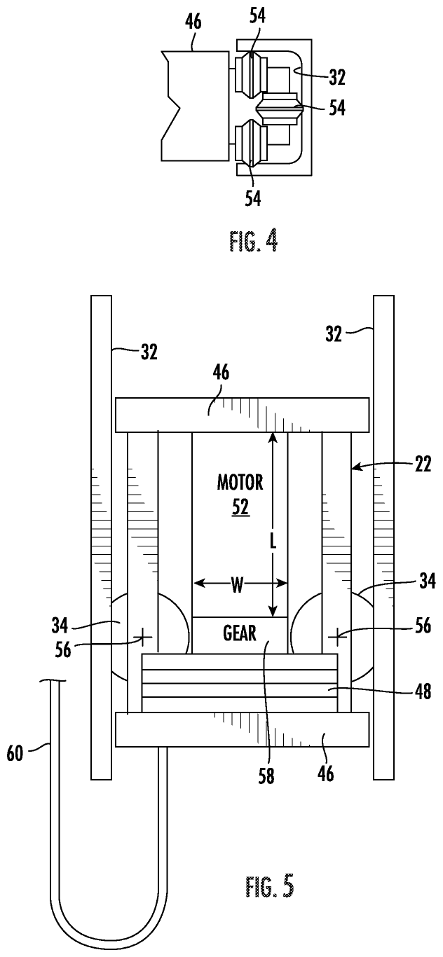

The wheels 50 have an exterior contour that is complementary to a contour of the vertical surfaces 32. Such a complementary contour facilitates guiding the counterweight 22 along the vertical surfaces 32. As shown in FIG. 4, the example counterweight 22 includes guide roller assemblies including guide rollers 54 that follow along the vertical surfaces 32, which have a generally C-shaped contour. In some embodiments the vertical surfaces 32 are on I-beams and FIG. 3 represents how a drive member 34 could engage one side or half of such a beam.

Another counterweight configuration is shown schematically in FIG. 5. In this example embodiment, the motor 52 is separated from the drive members 34. The motor 52 in this example is configured to save space in a hoistway by having a length L, which is greater than a width W, oriented parallel to the vertical surfaces 32. Such a motor configuration can facilitate a more compact counterweight design.

Each of the example counterweight configurations can be realized with a compact design. The vertical surfaces 32 face toward each other and the counterweight 22 including the drive mechanism 30 is received between the vertical surfaces 32. This type of arrangement places the elevator system drive within the space occupied by the counterweight and does not require reserving any other space in a hoistway or machine room for drive components.

Since the drive members 34 rotate about horizontal axes 56 in the illustrated embodiments, (see FIGS. 3 and 5) the drive mechanism 30 of FIG. 5 includes a gear set 58 that transmits rotary motion of a motor output shaft, which may be vertical, into rotary movement of the drive members 34.

Another feature shown in FIG. 5 is a traveling cable 60 that conveys at least power or control signals to the drive mechanism 30 on the counterweight 22. A traveling cable is sometimes provided for an elevator car but since the drive mechanism 30 is provided on the counterweight 22, the traveling cable 60 is included as shown.

In some embodiments, an on-board and remote or separate power source provide power to the drive mechanism 30. For example, the traveling cable 60 may carry power from a primary power source, such as grid power provided by a utility, and the on-board power source 44 may be used as a back-up power source. Some embodiments use a combination of on-board power and another power source to power the drive mechanism 30. A variety of power source configurations or combinations are possible.

A climbing counterweight 22 that includes a drive mechanism 30 to propel the counterweight 22 and elevator car 24 may include other combinations or sub-combinations of the features described above. The features of each example embodiment are not necessarily limited to the example embodiment and other combinations resulting in additional or different embodiments are possible.

An elevator system consistent with this description including a climbing counterweight with a drive mechanism that propels the counterweight and elevator car can have several beneficial features. The presence of the drive mechanism on the counterweight allows for maintenance or repair at any convenient location where the counterweight can be positioned instead of requiring a mechanic to enter a hoistway where a traction machine is otherwise located. For example, the car could be parked near a middle of the hoistway would position the counterweight near the car where the components on the counterweight are accessible to an individual on the car. Systems designed according to this description do not require any machine room, which improves the space-efficiency of the elevator system within a building or structure. Including a drive mechanism on a climbing counterweight eliminates the requirements of establishing traction between a drive sheave and the suspension assembly and the issues associated with ensuring adequate traction. Additionally, the location of the drive mechanism on the counterweight isolates the elevator car from the drive mechanism and any vibration or noise that the drive mechanism may introduce. This results in improved ride quality in many cases.

The features of the illustrated embodiments are not necessarily limited to the respective embodiments. Various combinations of the features of the example embodiments may be combined to realize additional embodiments.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator, comprising:
an elevator car;
a counterweight;
a suspension assembly coupling the counterweight to the elevator car; and
a drive mechanism on the counterweight, the drive mechanism including at least one rotatable drive member that is configured to engage a vertical surface near the counterweight, and selectively cause movement of the counterweight and corresponding movement of the elevator car as the at least one rotatable drive member rotates along the vertical surface.

2. The elevator of claim 1, wherein the at least one rotatable drive member comprises a wheel and a motor supported at least partially within the wheel.

3. The elevator of claim 1, wherein
the at least one rotatable drive member comprises a plurality of wheels,
one of the wheels is configured to engage one vertical surface near one side of the counterweight, and
another of the wheels is configured to engage another vertical surface near another side of the counterweight.

4. The elevator of claim 3, wherein
the vertical surfaces face toward each other, and
the counterweight is situated between the vertical surfaces.

5. The elevator of claim 1, comprising a biasing mechanism that urges the at least one rotatable drive member in a direction to engage the vertical surface.

6. The elevator of claim 1, wherein the drive mechanism establishes a portion of a mass of the counterweight.

7. The elevator of claim 6, wherein
the drive mechanism includes a motor for rotating the rotatable drive member,
the drive mechanism includes a power source for powering the motor, and
the motor and the power source establish some of the portion of the mass of the counterweight.

8. The elevator of claim 1, wherein
the drive mechanism includes a motor for rotating the rotatable drive member, and
the elevator comprises a traveling cable having one end associated with the counterweight to provide at least power or control signals to the motor to selectively cause the rotatable drive member to rotate.

9. The elevator of claim 1, wherein
the drive mechanism includes a motor configured to selectively cause rotation of the drive member,
the motor has a length and a width,
the length is greater than the width, and
the length is oriented parallel to the vertical surface.

10. The elevator of claim 1, wherein the at least one rotatable drive member is configured to selectively prevent movement of the counterweight and corresponding movement of the elevator car when the at least one rotatable drive member does not rotate relative to the vertical surface.

11. A method of controlling elevator car movement in an elevator system that includes an elevator car coupled to a counterweight by a suspension assembly, the method comprising operating a drive mechanism on the counterweight to cause at least one rotatable drive member of the drive mechanism that engages a vertical surface near the counterweight to rotate along the vertical surface to selectively cause movement of the counterweight and corresponding movement of the elevator car.

12. The method of claim 11, comprising operating the drive mechanism on the counterweight to cause the at least one rotatable drive member of the drive mechanism to remain stationary relative to the vertical surface to selectively prevent movement of the counterweight and corresponding movement of the elevator car.

13. The method of claim 11, comprising biasing the at least one rotatable drive member into engagement with the vertical surface.

14. The method of claim 13, wherein
the at least one rotatable drive member comprises a plurality of wheels,
one of the wheels is configured to engage one vertical surface near one side of the counterweight,
another of the wheels is configured to engage another vertical surface near another side of the counterweight,
the vertical surfaces face toward each other, and
the counterweight is situated between the vertical surfaces.

15. The method of claim 11, comprising using a mass of the drive mechanism to establish a portion of the mass of the counterweight.

16. The method of claim 11, comprising
determining a desired position of the elevator car,
determining a desired counterweight position corresponding to the desired position of the elevator car, and
moving the counterweight into the desired counterweight position.

17. The method of claim 16, comprising monitoring the position of the elevator car and moving the counterweight to place the elevator car in the desired position of the elevator car.

18. The method of claim 11, comprising
determining a desired position of the elevator car,
determining a current position of the elevator car, and
moving the counterweight to move the elevator until the current position of the elevator car corresponds to the desired position of the elevator car.

19. The method of claim 18, comprising adjusting a position of the elevator car near the desired position of the elevator car using a leveling and holding mechanism on the elevator car.

20. The method of claim 18, comprising determining a desired position of the counterweight corresponding to the desired position of the elevator car and wherein moving the counterweight includes moving the counterweight into the desired position of the counterweight and subsequently adjusting the position of the counterweight to move the elevator car into the desired position of the elevator car based on an indication of the current position of the elevator car.
